(19) United States
(12) Patent Application Publication
(10) Pub. No.: US 2003/0184566 A1
(43) Pub. Date: Oct. 2, 2003

(54) Triple point slope control scaling method

(76) Inventor: Kun-Nan Cheng, Hsinchu (TW)

Correspondence Address: J.C. Patents, Inc., 4 Venture, Suite 250, Irvine, CA, 92618, US

(21) Appl. No.: 10/335,301

(22) Filed: Dec. 31, 2002

Related U.S. Application Data
(60) Provisional application No. 60/369,530, filed on Apr. 1, 2002.

(51) Int. Cl. G09G 5/00

(52) U.S. Cl. 345/660

(57) ABSTRACT

A method for scaling a source signal to a destination signal within a considering region. The method includes setting a function of f(x)=ax²+bx+c for scaling the source signal, wherein a first derivative equation is f(x)′=2ax+b. A current reference point 0 is located with quantity of f(0). A front reference point −1 with quantity of f(−1) and a post reference point +1 with quantity of f(1) with respect to the current reference point f(0) are set. A slope relation at the current reference point 0 is determined to calculate b=f(0)′. The method also uses all or some of f(−1), f(0), and f(1) to get solution of a and b in f(x), whereby the coefficients of a, b, and c in f(x) is well defined. Then, the defined f(x) is used to obtain a quantity at a desired point x, which is a deviation from 0.

### CROSS-REFERENCE TO RELATED APPLICATION

This application claims the priority benefit of U.S. provisional application serial No. 60/369,530, filed on Apr. 1, 2002, the full disclosure of which is incorporated herein by reference.

### BACKGROUND OF THE INVENTION

1. Field of the invention

The present invention relates to a method of data scaling, and more particularly to a method of scaling up or down of different types of data such as graphics, image, video or audio data, and for application of polygon curve fitting in many area such as object moving tracking analysis, data analysis, a finder for object 2D shape or 3D surface in graphic area.

2. Description of related art

Scaling is useful in graphics, image, video or audio application for expanding or shrinking sample resolution and for zooming. Especially, in digital display device with fixed resolution, different kinds of source image format must be scaled to fit the resolution of the digital display.

For example, a display panel may have fixed resolution of 1024×768 pixels in XGA mode, but the source image may come from computer, video decoder, or others that the input resolution varies depending on the input modes. The input source of image in VGA mode (640×480 pixels) with resolution less that that of the display mode XGA needs to be scaled up when the image is to be displayed on the XGA panel. On the other hand, an input source of image in SXGA mode (1280×1024 pixels) with resolution greater than that of the display mode XGA needs to be scaled down when the image is to be displayed on the XGA panel. Image resizing is very important for digital display devices such as LCD. Various conventional well-known methods such as Bilinear, Cubic, B-Spline, or Besier have been proposed to achieve a good filtering effect for scaling purposes.

The Bilinear method is the most commonly used method of interpolation. It benefits in its simplicity, speed, and cost because only 2 reference points are taken. As a result, the cost of the implementation of the Bilinear method is low because computation and storage requirements are less compared to other high-order interpolation methods. However, the output of the Bilinear method is blurry due to lack of sharpness from the interpolation results and therefore is not suitable for text image. The sharpness of the picture quality depends on curve after fitting the interpolation points. The Bilinear method takes the weighting average as the interpolation result. When considering two neighbor pixels A, B, if the interpolation point C is located between A and B with distance D (D≦1) from A, then the interpolation result according to the Bilinear method is

C=A(1−D)+B D Eq. 1

Cubic or B-Spline methods are the more preferred methods used in high quality scaling system with almost perfect scaling quality, but the cost is very high for computation and storage. Cubic methods usually require 4 points ƒ(−1), ƒ(0), ƒ(1), and ƒ(2) as reference. The Cubic Curve using the Hermite Method has 1 start point P₁, 1 end point P₂, 1 start point tangent-vector R₁, and 1 end point tangent-vector R₂ by the formula

ƒ(x)=(2x³−3x²+1)P₁+(−2x³+3x²)P₂+(x³−2x²+x)R₁+(x³−x²)R₂ Eq. 2

=(2P₁−2P₂+R₁+R₂)x³+(−3P₁+3P₂−2R₁−R₂)x²+R₁x+P₁ Eq. 3

where

P₁=ƒ(0),

P₂=ƒ(1),

R₁=G₁(P₂−P₀)/2=G₁[ƒ(1)−ƒ(−1)]/2=tangent-vector at P1

R₂=G₂(P₃−P₁)/2=G₂[ƒ(2)−ƒ(0)]/2=tangent-vector at P2

G₁, G₂ are gain factors, wherein the gain factors are proportional to the sharpness of the scaling result.

In the foregoing two conventional methods, Bilinear method can be easily implemented. However, the interpolation result only depends on quantites of two points. When the change of quantity at certain region ranging has large variation, the image after scaling would lose the fidelity. For the Cubic or B-Spline methods, more information is included, but the implement would be more complex and the cost is high. The computation is more tedious. So, the foregoing conventional methods still have their disadvantages.

### SUMMARY OF THE INVENTION

The present invention provides a low cost and high performance in scaling algorithm triple point slope control (TPSC) scaling method for both shrinking and zooming purposes with a second order equation. The quality of the TPSC method can be compared with the Cubic or B-Spline methods, while keeping the cost approximately equal to that of the Bilinear method. The TPSC method of the present invention requires only three reference source points for generating interpolation points with high quality and a much lower storage requirement comparing to that of Cubic or B-Spline methods. Therefore the cost of storage and implementation is also lowered. Each piece of destination data can be generated with three reference source points. A special slope control is used to control the sharpness of the interpolation result. The interpolation curve passes the source sample points and the interpolation points to generate destination data for display. The slope of the starting source point can be defined in three different ways: single slope, cross slope or Cubic-like slope. These three different ways of defining a slope generates different scaling results. Furthermore, the present invention imposes an adjustable slope gain on the slope allowing the adjustments of the scaling quality. Different start point slope gain affects the scaling results. The TPSC method of the present invention provides simple and adjustable high-quality scaling at a lower cost comparing to other high order scaling methods.

The present invention provides a method for scaling a source signal to a destination signal within a considering region. The method includes setting a function of f(x)=ax²+bx+c for scaling the source signal, wherein a first derivative equation is f(x)′=2ax+b. A current reference point 0 is located with quantity of f(0). A front reference point −1 with quantity of f(−1) and a post reference point +1 with quantity of f(1) with respect to the current reference point f(0) are set. A slope relation at the current reference point 0 is determined to calculate b=f(0)′. The method also uses all or some of f(−1), f(0), and f(1) to get solution of a and b in f(x), whereby the coefficients of a, b, and c in f(x) is well defined. Then, the defined f(x) is used to obtain a quantity at a desired point x, which is a deviation from 0.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is an application of the single slope method of TPSC scaling of present invention;

FIG. 2 is an application of the cross slope method of TPSC scaling of present invention;

FIG. 3 is an application of the Cubic-like slope method of TPSC scaling of present invention;

FIG. 4 shows an edge behavior of the single slope method of TPSC scaling in a block pattern of present invention;

FIG. 5 shows an edge behavior of the cross slope method of TPSC scaling in a block pattern of present invention;

FIG. 6 shows an edge behavior of the Cubic-like slope method of TPSC scaling in a block pattern of present invention;

FIG. 7 is an example of scaling with a scaling factor of 0.75 by the TPSC scaling of the present invention; and

FIG. 8 is an application on a 2D-object shape using the single slope TPSC scaling of present invention.

### DETAILED DESCRIPTION OF THE PREFERRED EMBODIMENTS

The theory employed by the present invention is shown in the following mathematical equations involving the calculations and general understanding of simple algebra and calculus.

A general second order curve is given as

ƒ(x)=ax²+bx+c. Eq. 4

The first derivative equation is

ƒ(x)=2ax+b, Eq. 5

which represents the slope of the curve at any given position x. If we know ƒ(−1), ƒ(0), ƒ(1) as the source image reference points, then we can define a curve that passes through the 2 existed points ƒ(0) and ƒ(1) with a start point slope ƒ(0) at ƒ(0).

Define

DG: start point slope=ƒ(0) at ƒ(0) Eq. 6

where the initial conditions:

ƒ(0)=b=DG Eq. 7

ƒ(0)=c Eq. 8

ƒ(1)=a+b+c Eq. 9

the solution of ƒ(x) preferably in 0≦x<1 will be

ƒ(x)=[ƒ(1)−ƒ(0)−DG]x²+DGx+ƒ(0) Eq. 10

However, Eq. 10 is not the unique form. For example, Eq. 4 can be expressed by Eq. 10a as follows:

ƒ(x)=[ƒ(−1)−ƒ(0)+DG]x²+DGx+ƒ(0). Eq. 10a

In general, Eq. 4 includes three parameters for the coefficients, so that three points have been sufficient. Wherein, the parameter x is a deviation from the current initial point at x=0. The Eq. 10 basically is applied for 0≦x<1, where the Eq. 10a is applied for −1<x≦0. Actually, the difference is a design choice but the principle introduced in the invention is the same.

The advantages of the TPSC method are cost-efficient, simple, and high quality with a scaling result comparable to that of the conventional scaling algorithm “Cubic” method which requires 4 points (ƒ(−1), ƒ(0), ƒ(1), ƒ(2)). The scaling quality is directly related to the start point slope DG, which can be defined in three different methods: single slope, cross slope, and cubic-like slope providing highest quality scaling.

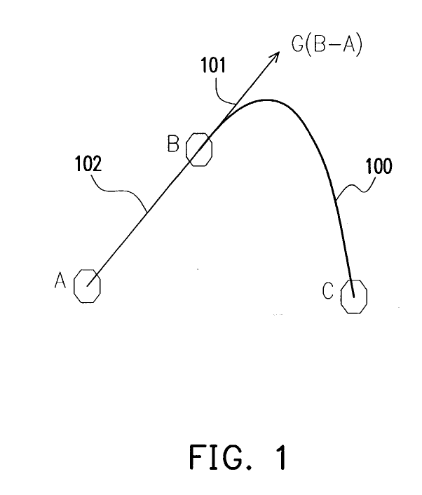

FIG. 1 shows an application of the single slope method of TPSC scaling. Curve 100 is the interpolation curve between points B and C using TPSC single slope method. Curve 102 between points A and B is a supposed line, and curve 101 shows the slope at point B. Curve 101 is an extension of the curve 102 at point B where the slope of B is equal to G(B−A), where G is the gain factor. The detailed derivation is as follows:

Define

DG=[ƒ(0)−1)]G Eq. 11

wherein G is a gain factor>0

Let ƒ(−1)=A Eq. 12

ƒ(0)=B Eq. 13

ƒ(1)=C Eq. 14

Given a general solution ƒ(x)=ax²+bx+c

Apply ƒ(0) c=B; Eq. 15

ƒ(1)=a+b+c=C; Eq. 16

ƒ(0)=b=G[ƒ(0)−ƒ(−1)]=G(B−A)=DG; Eq. 17

thus, we get

a=(C−B)−DG=[ƒ(1)−ƒ(0)]−DG; Eq. 18

b=DG=G(B−A)=G[ƒ(0)−ƒ(−1)]; Eq. 19

c=B=ƒ(0). Eq. 20

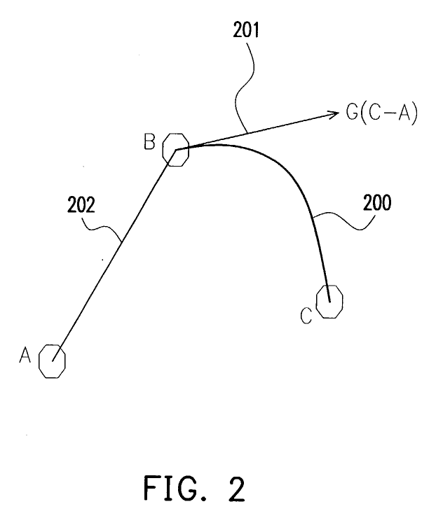

FIG. 2 shows an application of the cross slope method of TPSC scaling. Curve 200 is the interpolation curve between points B and C using TPSC cross slope method. Curve 202 between points A and B is a supposed line and curve 201 shows the slope at point B. The slope at B is equal to G(C−A), where G is the gain factor. The cross slope method requires referencing both point A and point C to achieve a good curve adjustment. It is good for a slash edge to get a smooth scaling effect without alias. The detailed derivation is as follows:

Define

DG=[ƒ(1)−ƒ(−1)]G Eq. 21

G is a gain factor>0

Let ƒ(−1)=A

ƒ(0)=B

ƒ(1)=C

Given a general solution ƒ(x)=ax²+bx+c

Apply ƒ(0)=c=B Eq. 22

ƒ(1)=a+b+c=C Eq. 23

ƒ′(0)=b=G[ƒ(1)−ƒ(−1)]=G(C−a)=DG Eq. 24

thus, we get

a=(C−B)−DG=[ƒ(1)−ƒ(0)]−DG; Eq. 25

b=DG=G(C−A)=G[ƒ(1)−ƒ(−1)]; Eq. 26

c=B=ƒ(0). Eq. 27

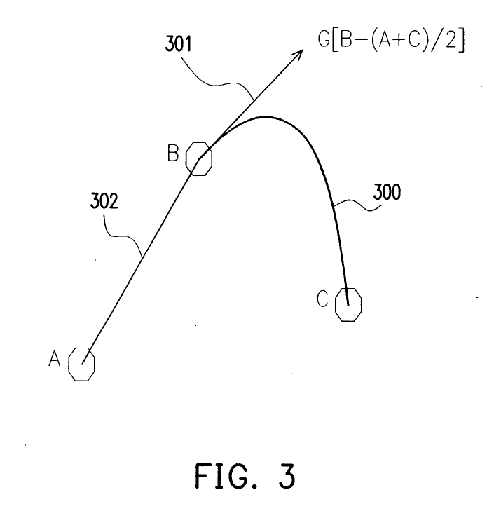

FIG. 3 shows an application of the cubic-like slope method. The curve 300 is the interpolation curve between points B and C using TPSC cubic-like slope method. The curve 302 between points A and B is a supposed line and the curve 301 is the slope at point B. The slope of B is equal to G[B−(A+C)/2], where G is the gain factor. The cubic-like slope method takes three reference points to calculate the slope of curve 310 at point B. The three points A, B and C are used as reference point to calculate the slope. The detailed derivation is as follows:

Define

DG=[ƒ(0)−(ƒ(−1)+ƒ(1))/2]G Eq. 28

G is a gain factor>0

Let ƒ(−1)=A

ƒ(0)=B

ƒ(1)=C

Given a general solution ƒ(x)=ax²+bx+c

Apply ƒ(0)=c=B Eq. 29

ƒ(1)=a+b+c=C; Eq. 30

ƒ′(0)=b=G[B−(A+C)/2]=DG Eq. 31

thus, we get

a=(C−B)−DG=[ƒ(1)−ƒ(0)]−DG Eq. 32

b=DG=G[B−(A+C)/2]=G[ƒ(0)−(ƒ(−1)+ƒ(1))/2] Eq. 33

c=B=ƒ(0) Eq. 34

During interpolation using the methods described above, there is a phenomena known as curve overshot or undershot when the interpolated curve actually shots over or under creating a peak that is further away from the original peak. In the single slope and cross slope methods, curve overshot and undershot occurs on one side of a block pattern, which produces two edges. An edge occurs when pixel value changes from low to high or high to low. The block pattern represents the pixels value keeping at low for a period, then going to high and maintaining at high for another period, and finally going back to low.

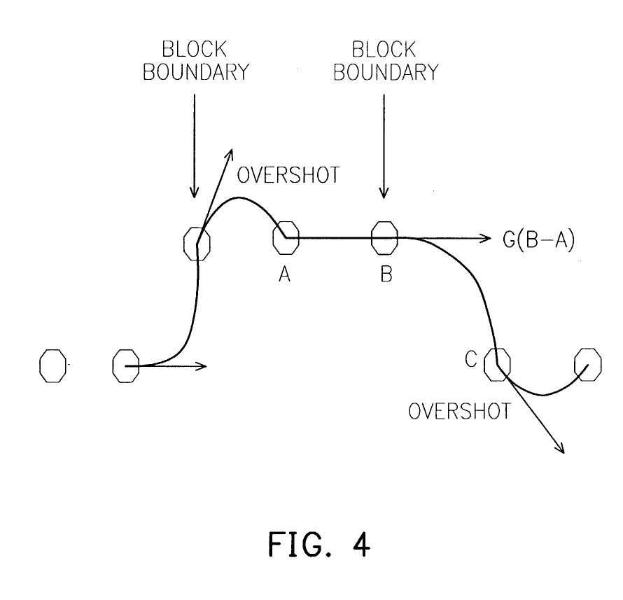

FIG. 4 shows the edge behavior of the single slope method of TPSC curve in a block pattern wherein the gain factor G=2 is taken as an example. One overshot in the curve is present on the left side of the block pattern and one undershot in the curve is present on the right side of the block pattern. The overshot and undershot in the curve can be controlled by the gain factor of the slope G. The quality of scaling increases with greater sharpness as the emphasis on the edge increases.

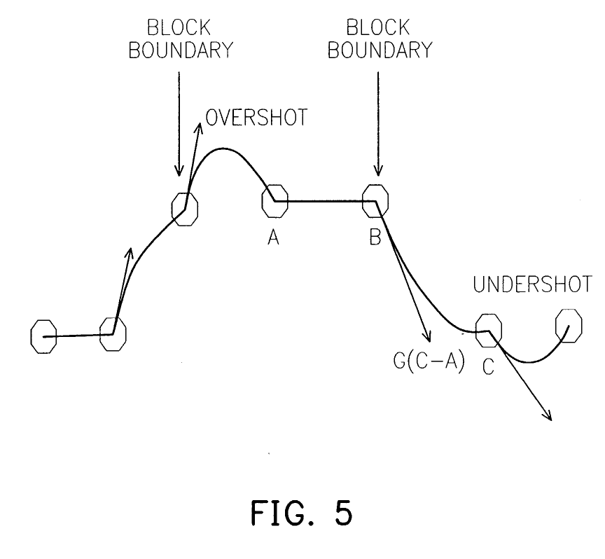

FIG. 5 shows the edge behavior of the cross slope method of TPSC curve in a block pattern wherein the gain factor G=2 is taken as an example. One overshot is present on the left side of the block pattern, and one undershot is present at the right side of the block pattern. The quality is good for edge emphasize while G is getting large. The overshot and undershot in the curve can be controlled by the gain factor of the slope G. The quality of scaling increases with greater sharpness as the emphasis on the edge increases.

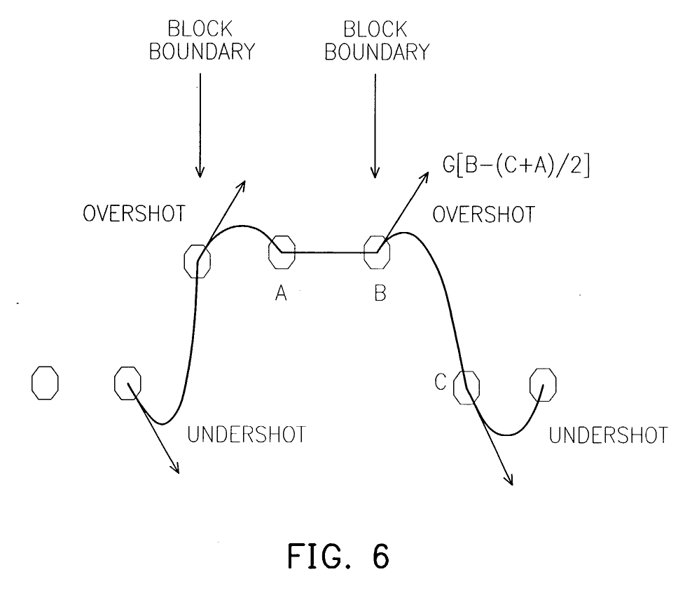

FIG. 6 shows the edge behavior of the Cubic-like slope method of TPSC curve in a block pattern wherein the gain factor G=2 is taken as an example. One overshot and one undershot are present both on the left side of the block pattern and on the right side of the block pattern. This gives a two side emphasis scaling effect which produces very sharp and high quality images. The scaling quality is better by increasing edge emphasis when G gets larger. The cubic effect emphasizes both edges of a block so the Cubic-like slope method of the present invention simulates the cubic effect.

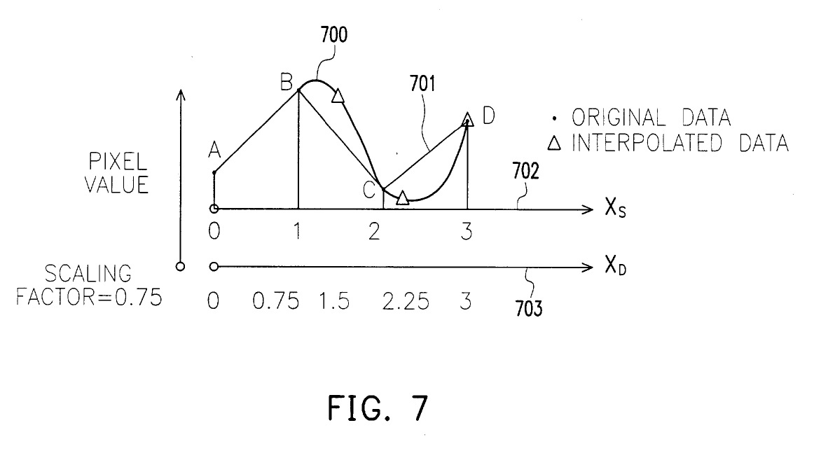

FIG. 7 shows the implementation of the TPSC method in accordance with the present invention. Curve 700 is the curve using TPSC method and curve 701 is the Bilinear curve for comparison reasons. X_{S} 702 is the source data location and X_{D} 703 is the destination interpolation data location. For zoom and shrink purposes, the procedure is as follow:

a. X_{S} denotes the position coordinate with original data D₀, D₁, D₂, D₃ . . . D_{M}, where x=0,1,2,3 . . . , M

b. A scaling factor generator generates the interpolation location X_{D}. The Scaling factor is decided by (input resolution)/(output resolution), and the preferred embodiment uses 0.75 as an example. Scaling factor <1 is an up scaling case, while scaling factor >1 is a down scaling case. For interpolation points x locate between the coordinate x=N to x=N+1.

Given

ƒ(−1)=D_{N-1}

ƒ(0)=D_{N}

ƒ(+1)=D_{N+1}

And x=0 . . . 1 (truncate the integer part N)

c. Apply DG by selecting one of the methods, G>0

Single Slope: DG=[ƒ(0)−ƒ(−1)]G

Cross Slope: DG=[ƒ(1)−ƒ(−1)]G

Cubic-like Slope: DG=[ƒ(0)−(ƒ(−1)+ƒ(1))/2]G

d. Apply

ƒ(x)=(ƒ(1)−ƒ(0)−DG)x²+(DG)x+ƒ(0) Eq. 35

for the range x=0 . . . 1

e. Get ƒ(x),ƒ(x) 700 denotes the data after scaling or shrink at point x.

The TPSC method is good for zooming and shrinking in graphic, image, video or audio data but also suitable for application of polygon curve fitting in many area such as object moving tracking analysis, data analysis, a finder for object 2D shape or 3D surface in graphic area.

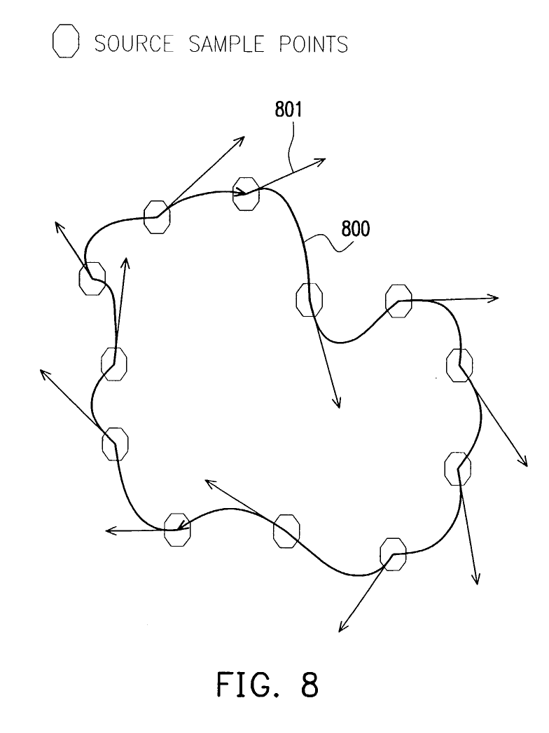

FIG. 8 shows the 2D object shape application using single slope TPSC curve of present invention as a finder. The Curve 800 is the boundary shape of given source sample points using the TPSC method of the present invention. The curve 801 represents the start point slope DG. By using sample point and selecting shape control points according to the TPSC method, the entire curve 800 can be generated which represents the boundary of object surrounding by sample points.

The TPSC scaling method of the present invention is low cost and high performance in scaling compared to the higher-order methods such as Cubic or B-Spline methods. By defining the start point slope and gain DG by using either single slope, cross slope, or cubic-like method, the scaling quality can be controlled and adjusted. The computation, processing, and storage requirement are only a little bit greater than that of Bilinear method but considerably less than that of Cubic or B-Spline methods because TPSC scaling method only requires 3 reference points. Furthermore a sharper and crispier image is achieved in scaling up a source image as compared to the blurry image output using the Bilinear method. It is very important during vertical scaling that the whole line of image data must stored as a whole in the line buffer. The more the reference points, means more line buffers are required but the TPSC method of the present invention only requires a minimum of 3 line buffers for 3 reference points. The present invention is excellent in many applications like in scaling of graphic, image, video, audio, or polygon curve fitting applications, moving tracking analysis, data analysis, or finder for object 2D shape or 3D surface in graphic area.

As mentioned in Eq. 10a, the function f(x) can also be expressed using f(−1) and f(0). Also and, if the extrapolation is applied, it has the similar principle to the interpolation. However, the same principle for the different types of slops can also be applied. The present invention use the second order curve, in which f(x)′ with respect to the slop of the curve can be easily implemented. As a result, the present invention can have greatly simple algorithm to perform he interpolation but can still maintain the quality of the interpolation.

Also and, the foregoing method can be implemented by hardware, firmware, software or other feasible forms to perform the scaling process.

It will be apparent to those skilled in the art that various modifications and variations can be made to the structure and method of the present invention without departing from the scope or spirit of the present invention. In view of the foregoing description, it is intended that the present invention covers modifications and variations of this invention provided they fall within the scope of the following claims and their equivalents.

What is claimed is:

1. A method for scaling a source signal to a destination signal within a considering region, the method comprising:
setting a function of f(x)=ax²+bx+c for scaling the source signal, wherein a first derivative equation is f(x)′=2ax+b;
locating a current reference point 0 with quantity of f(0);
setting a front reference point −1 with quantity of f(−1) and a post reference point +1 with quantity of f(1) with respect to the current reference point f(0);
determining a slope relation at the current reference point 0 to calculate b=f(0)′;
using all or some of f(−1), f(0), and f(1) to get solution of a and b in f(x), whereby the coefficients of a, b, and c in f(x) is well defined; and
using the defined f(x) to obtain a quantity at a desired point x, which is a deviation from 0.

2. The method of claim 1, wherein the source signal is scaled to the destination signal by interpolation or extrapolation.

3. The method of claim 1, wherein the slop relation D comprises one selected from the group consisting a single slope, a cross slope, and a cubic-like slope.

4. The method of claim 3, wherein a gain factor G is included in the slop relation D.

5. The method of claim 1, wherein the step of using all or some of f(−1), f(0), and f(1) to get solution of a and b in f(x) comprising:
setting ƒ(x)=[ƒ(1)−ƒ(0)−DG] x²+DG x+ƒ(0), wherein G is the gain factor and D is the slope of the point 0,
wherein DG=f(0)′=b, f(0)=c, and f(1)=a+b+c.

6. The method of claim 5, wherein the method is used in scaling on a graphic data, an image data or a video data, in audio operation, in polygon curve fitting, object moving tracking analysis, data analysis, or finder for object 2D shape or 3D surface in graphic area.

7. The method of claim 5, wherein the desired point x is within a range of 0≦x<1.

8. The method of claim 5, wherein the DG is set to have one selected from the group consisting of DG=[ƒ(0)−ƒ(−1)]G, DG=[ƒ(1)−ƒ(−1)]G, and DG=[ƒ(0)−(ƒ(−1)+ƒ(1))/2]G, with respect to a single slope, a cross slop, and a Cubic-like slop.

9. A circuit, using a triple point slope control (TPSC) curve to perform a scaling on graphic data, image data and video data, a polygon curve fitting, an object moving tracking analysis, a data analysis, or a finder for object 2D shape or 3D surface in graphic area,, wherein the TPSC curve is determined by:
ƒ(x)=[ƒ(1)−ƒ(0)−DG] x²+DG x+ƒ(0), wherein G is the gain factor and D is the slope of the point 0,
wherein DG=f(0)′=b, f(0)=c, and f(1)=a+b+c,
and DG comprising one selected the group consisting of DG=[ƒ(0)−ƒ(−1)]G, DG=[ƒ(1)−ƒ(−1)]G, and DG=[ƒ(0)−(ƒ(−1)+ƒ(1))/2]G,
where f(−1), f(0). f(1) are a quantity at a front reference point −1, a current reference point 0, and a post reference point +1, and the parameter x is a deviation from the current reference point 0 at a desired point, and f(x) is a scaled result at the desired point.

10. A system, using a triple point slope control (TPSC) curve to perform a scaling on graphic data, image data and video data, a polygon curve fitting, an object moving tracking analysis, a data analysis, or a finder for object 2D shape or 3D surface in graphic area,, wherein the TPSC curve is determined by:
ƒ(x)=a x²+b x+c=[ƒ(1)−ƒ(0)−DG] x²+DG x+ƒ(0), wherein G is the gain factor and D is the slope of the point 0,
wherein DG=f(0)′=b, f(0)=c, and f(1)=a+b+c,
and DG comprising one selected the group consisting of DG=[ƒ(0)−ƒ(−1)]G, DG=[ƒ(1)−ƒ(−1)]G, and DG=[ƒ(0)−(ƒ(−1)+ƒ(1))/2]G,
where f(−1), f(0). f(1) are a quantity at a front reference point −1, a current reference point 0, and a post reference point +1, and the parameter x is a deviation from the current reference point 0 at a desired point, and f(x) is a scaled result at the desired point.

11. A method for generating output data sample f(x) for a point x in response to input data samples f(−1), f(0) and f(1) wherein f(x) is generated for x in a range of 0≦x<1, the method comprising the following steps of:
(a) fitting a quadratic equation of f(x)=ax²+bx+c to said input data samples f(0) and f(1); and
(b) generating a resulting equation of f(x)=[f(1)−f(0)−DG] x²+DGx+f(0)
wherein G is a gain factor and D is generated in response to at least two of f(−1), f(0) and f(1).

12. The method as claimed in claim 11, wherein D is equal to [f(0)−f(−1)].

13. The method as claimed in claim 11, wherein D is equal to [f(1)−f(−1)].

14. The method as claimed in claim 11, wherein D is equal to [f(0)−(f(−1)+f(1))/2].

15. A method for generating output data sample f(x) for a point x in response to input data samples f(−1), f(0) and f(1) wherein f(x) is generated for x in a range of −1<x≦0, the method comprising the following steps of:
(a) fitting a quadratic equation of f(x)=ax²+bx+c to said input data samples f(0) and f(−1); and
(b) generating a resulting equation of f(x)=[f(−1)−f(0)+DG] x²+DGx+f(0)
wherein G is a gain factor and D is generated in response to at least two of f(−1), f(0) and f(1).

16. The method as claimed in claim 15, wherein D is equal to [f(0)−f(1)].

17. The method as claimed in claim 15, wherein D is equal to [f(−1)−f(1)].

18. The method as claimed in claim 15, wherein D is equal to [f(0)−(f(1)+f(1))/2].
